(19) United States
(12) Patent Application Publication
(10) Pub. No.: US 2005/0090228 A1
(43) Pub. Date: Apr. 28, 2005

(54) Apparatus and method for mitigation of session unavailability

(76) Inventor: Greg R. Black, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 10/692,196

(22) Filed: Oct. 23, 2003

(51) Int. Cl. H04M 11/00

(52) U.S. Cl. 455/405; 455/403

(57) ABSTRACT

An apparatus and method of messaging service message control on a wireless communication device. The push-to-talk usage of a device is monitored. A push-to-talk metric is determined based on the push to talk usage of the device. A push-to-talk session unavailability mitigation is selected based on the push-to-talk metric. The session unavailability can be a delay of an activation of a push-to-talk session, an interruption of a push-to-talk session, or any other event that can adversely affect a push-to-talk session.

### BACKGROUND

1. Field

The present disclosure is directed to a method and apparatus for mitigation of session unavailability. More particularly, the present disclosure is directed to mitigation of delay and interruption of a push-to-talk session.

2. Description of Related Art

Presently, push-to-talk sessions can be used for one-way communications between users of communication devices. For example, one user can establish a push-to-talk session by pressing a push-to-talk button on a communication device. The user can then send communications to other users of other communication devices. When the user releases the button, the session ends. If the user decides to continue communicating, the user can press the button again to establish a subsequent session from the same communication device. Also, another user of another communication device can establish a subsequent reverse or return session to communicate back to the original user.

Unfortunately, users can experience session unavailability of a push-to-talk session. One type of session unavailability results from a delay of activation of a push-to-talk session. For example, there can be delays involved with setting up a push-to-talk session, which result in delayed communications. These delays can result from using a circuit switched network having slow set-up times caused from terminal authentication and radio resource assignment procedures, for example, or from other delays.

Another type of session unavailability results from an interruption of a push-to-talk session. For example, inter-cell user mobility may result in interruption of a session when the communication device moves into a new cell, crosses a routing area boundary, moves into an area served by another service network, or engages in other actions that cause interruptions. More particularly, in a packet switched system, when a communication device moves into a new cell, interruptions of up to four seconds can result from the packet transfer being stopped and then restarted in the new cell. Also, when a communication device crosses a routing area boundary, interruptions of up to eight seconds can result from performing a routing area update procedure to allow data to take a different path within a core network. Additionally, when a communication device moves into another area served by another service network, additional interruptions may occur if a newly selected cell does not support a service type being used, such as general packet radio service or any other service type, or does not have the necessary capacity available at the instant of cell change.

The problems with session unavailability become more egregious because different circumstances can result in different session unavailability problems. For example, while a circuit switched connection may cause delays in activating a session, the circuit switched connection can result in less session interruption. Also, while a packet switched connection may result in a higher probability of session interruption, the packet switched connection can result in less session activation delays. Other access modes or channel types may also provide tradeoffs in benefits and detriments.

Thus, there is a need for an improved method and apparatus for mitigation of session unavailability.

### BRIEF DESCRIPTION OF THE DRAWINGS

The embodiments of the present invention will be described with reference to the following figures, wherein like numerals designate like elements, and wherein:

FIG. 1 is an exemplary block diagram of a system according to one embodiment;

FIG. 2 is an exemplary block diagram of a mobile communication device according to one embodiment;

FIG. 3 is an exemplary flowchart illustrating the operation of a controller according to one embodiment;

FIG. 4 is an exemplary flowchart illustrating the operation of a controller according to another embodiment; and

FIG. 5 is an exemplary block diagram of an unavailability mitigation module according to one embodiment.

### DETAILED DESCRIPTION

The disclosure provides an apparatus and method for mitigation of session unavailability. More particularly, the present disclosure is directed to mitigation of delay and interruption of a push-to-talk session.

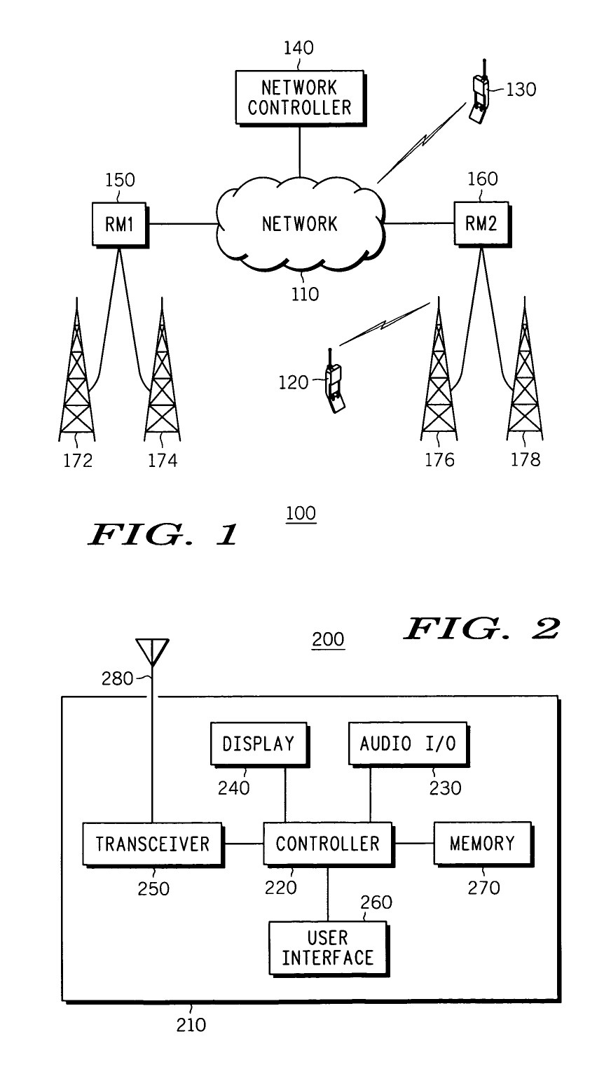

FIG. 1 is an exemplary block diagram of a system 100 according to one embodiment. The system 100 can include a network controller 140, a network 110, one or more terminals 120 and 130, one or more resource managers 150 and 160, and one or more base stations 172, 174, 176, and 178. Terminals 120 and 130 may include telephones, wireless telephones, cellular telephones, PDAs, pagers, personal computers, or any other device that is capable of sending and receiving signals on a network.

In an exemplary embodiment, the network controller 140 is connected to the network 110. For example, the network controller 140 may be located at a resource manager 150, at a base station 172, or anywhere else on the network 110. The network 110 may include any type of network that is capable of employing push-to-talk sessions. For example, the network 110 may include a wireless telecommunications network, a cellular telephone network, a satellite communications network, and other like communications systems capable of sending and receiving communication signals. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving signals.

In operation, terminals 120 and 130 can be used to engage in a push-to-talk session. When a subscriber uses a terminal 120, for example, to establish a push-to-talk session with another terminal 130, the terminal 120 can establish a connection with a base station 172. A communication signal can be sent to the terminal 130 using the base station 172, the resource manager 150, the network controller 140, and the network 110.

FIG. 2 is an exemplary block diagram of a mobile communication device 200, such as the terminal 120 or the terminal 130, according to one embodiment. The mobile communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and a electronic device. The memory 270 may include a random access memory, a read only memory, an optical memory, a subscriber identity module memory, or any other memory that can be coupled to a mobile communication device.

In operation, the controller 220 controls the operations of the mobile communication device 200. For example, the controller 200 can establish a push-to-talk session with the system 100 via the transceiver 250.

According to one embodiment, either the network controller 140 or the controller 220 can be used to mitigate push-to-talk session unavailability. For example, either controller can operate to mitigate delays in a push-to-talk session and interruptions of a push-to-talk session. In particular, either controller can mitigate push-to-talk session unavailability by monitoring push-to-talk usage of a mobile communication device 120, determining a push-to-talk metric based on the push to talk usage of the mobile communication device 120, and selecting a push-to-talk session unavailability mitigation based on the push-to-talk metric. The session unavailability can be a delay of an activation of a push-to-talk session, an interruption of a push-to-talk session, or any other event that can adversely affect a push-to-talk session.

For example, the session unavailability mitigation can be a mitigation of delay of an activation of a push-to-talk session. To mitigate the delay of an activation of a push-to-talk session, a packet switched channel type can be selected or a reverse link can be established for a selected time period, in anticipation that a reverse push-to-talk session is established. For example, a reverse link can be established with the terminal 130 when a user of the terminal 120 releases a push-to-talk button ending a push-to-talk communication with the terminal 130. Then, the reverse link can allow a user of the terminal 130 to communicate back to the terminal 130 without any set-up delay. This reverse link can be established for a selected time period. Thus, the link can be ended if the user of the terminal 130 does not respond within the selected time period.

Also, to mitigate the delay of an activation of a push-to-talk session, a push-to-talk connection can be held for a selected time period after release of a push-to-talk button, in anticipation that a subsequent push-to-talk session is established. Thus, if a user quickly continues a push-to-talk communication, no set-up delay is encountered.

The session unavailability mitigation can also be a mitigation of interruption of a push-to-talk channel. To mitigate the interruption of a push-to-talk channel, a circuit switched channel type can be selected or a network handover of the mobile communication device can be prohibited for a selected time period. For example, when the terminal 120 is moving from a coverage area of a base station 176 to the coverage area for another base station 178, handoff can be prohibited to avoid an interruption of a push-to-talk session due to the handoff. Also, when the terminal 120 is moving from a coverage area of a base station 176 controlled by one resource manager 160 or service provider to the coverage area for another base station 174 controlled by another resource manager 150 or service provider, handoff can be prohibited to avoid an interruption of a push-to-talk session due to the handoff.

Push-to-talk metrics can be used to adjust a mitigator or to determine which mitigator should be used. The push-to-talk metric can be based on a measurement of a length of a delay of a push-to-talk channel activation. The push-to-talk metric can additionally be based on a time measurement of the length of time of a push-to-talk channel interruption. The push-to-talk metric can further be based on a probability of a push-to-talk channel interruption.

The push-to-talk metric can also be based on a time between subsequent push-to-talk sessions from the same mobile communication device. For example, after a user releases a push-to-talk button to end a first session, the length of time can be measured between the first session and a subsequent session activated by the user. Also, the push-to-talk metric can be based on a probability of an activation of a subsequent push-to-talk session. For example, the frequency of subsequent sessions can be measured to determine the probability of subsequent sessions by the same user.

Furthermore, the push-to-talk metric can be based on the probability of a push-to-talk session from one mobile communication device and a subsequent push-to-talk session from another mobile communication device on a reverse channel. For example, to mitigate delay, a controller can initiate a reverse channel session automatically if there is a high probability of another device, such as terminal 130, returning a communication to another device, such as terminal 120. The push-to-talk metric can also be based on a length of time of a push-to-talk session. Thus, if a user has relatively short push-to-talk sessions handoff can be prevented. However, if a user has relatively long push-to-talk sessions where handoff prevention would result in a dropped call, handoff can be allowed. The push-to-talk metric can additionally be based on a probability of handoff of the push-to-talk session. For example, this metric can be based on a measurement of the mobility, such as the velocity, of a terminal 120.

According to a related embodiment, either controller can mitigate push-to-talk session unavailability by comparing at least one push-to-talk usage metric to a push-to-talk usage metric threshold, selecting a session unavailability mitigation based on comparing the push-to-talk usage metric to the push-to-talk usage metric threshold, establishing a push-to-talk session employing the session unavailability mitigation, monitoring a parameter of operation of the push-to-talk session, and modifying the push-to-talk metric based on the parameter of operation of the push-to-talk session. As discussed above, the session unavailability can be a delay of an activation of a push-to-talk channel or an interruption of a push-to-talk channel. A session unavailability mitigation parameter can then be modified as a function of a push-to-talk usage metric. For example, a parameter of operation related to a metric, like the delay between subsequent sessions from the same user, the probability of a subsequent session, or any other related metric, can be measured and compared against a threshold. In particular, if a user often initiates a subsequent session in a time period of less than the threshold, a mitigator can be used to maintain the session for a specific period of time. Then, for example, the session unavailability mitigation parameter can be a time to delay the end of a push-to-talk session after a user releases a push-to-talk button. The session unavailability mitigation parameter can also be a selection of a circuit switched push-to-talk session and a packet switched push-to-talk session. The session unavailability mitigation parameter can additionally be a duration of a reverse push-to-talk session from another mobile communication device.

According to another related embodiment, either controller can mitigate push-to-talk session unavailability by loading at least one push-to-talk mitigation parameter, executing a push-to-talk algorithm to configure at least one push-to-talk session unavailability mitigation based on the push-to-talk mitigation parameter, the push-to-talk session unavailability mitigation controlling the operation of a push-to-talk function of the mobile communication device, establishing a push-to-talk session for the mobile communication device, monitoring at least one metric of push-to-talk operation of the mobile communication device, modifying a push-to-talk mitigation parameter based on the at least one metric of push-to-talk operation of the mobile communication device, and reconfiguring the at least one push-to-talk session unavailability mitigation based on the modified push-to-talk mitigation parameter.

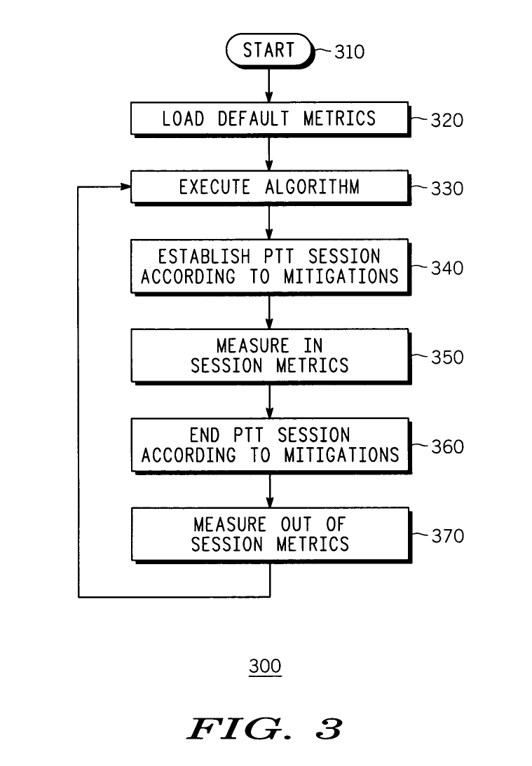

FIG. 3 is an exemplary flowchart 300 illustrating the operation of the controller 220 or the network controller 140 according to another embodiment. In step 310, the flowchart begins. In step 320, default metrics are loaded into either controller. In step 330, an algorithm is executed to configure and/or enable mitigators for push-to-talk session operation. In step 340, a push-to-talk session is established between two terminals according to the selected mitigations and mitigation parameters. In step 350, metrics or parameters of operation are measured during the push-to-talk session. For example, as discussed above, these metrics can include interruption time, interruption probability, delay time, or any other useful metrics for mitigating channel unavailability during a push-to-talk session. In step 360, the push-to-talk session is ended according to selected mitigations and mitigation parameters. For example, the end of the session may be delayed for a selected period after a push-to-talk button is released if there is a high probability of another session during the selected time period. In step 370, out of session metrics are measured. For example, as discussed above, these metrics can include average delay time or probability of subsequent forward or reverse sessions, or any other useful metrics for mitigating channel unavailability during a push-to-talk session. Any metrics can be measured at any useful points during or between push-to-talk sessions and at any point during the flowchart 300.

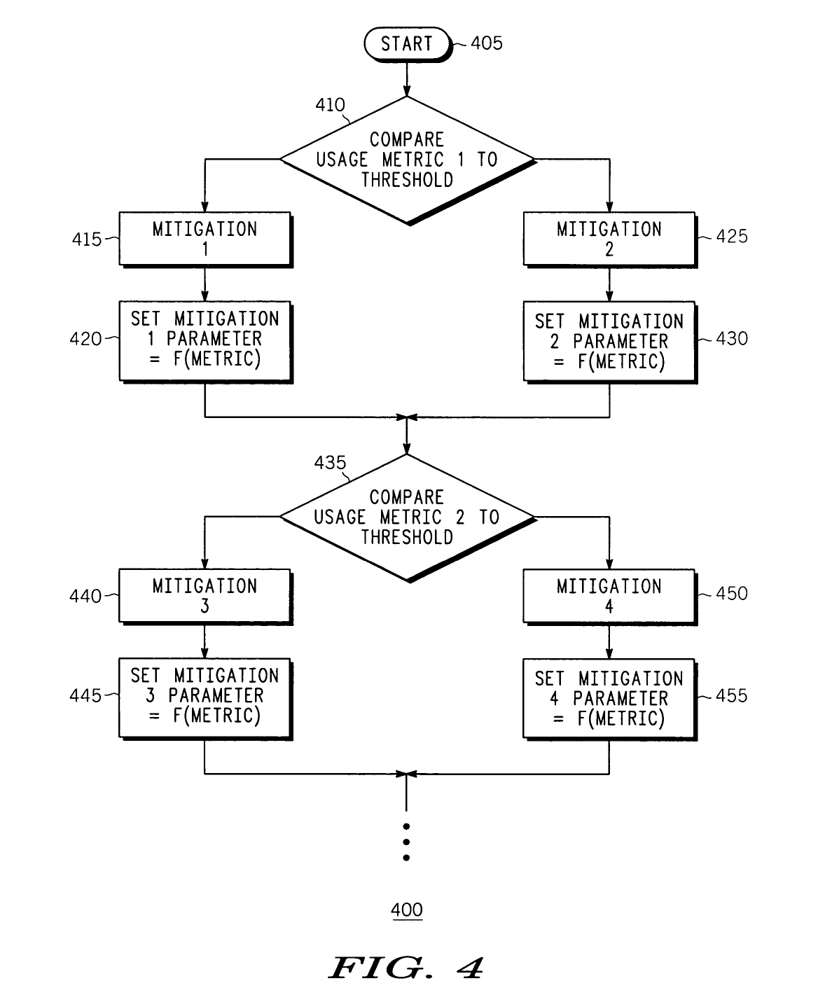

FIG. 4 is an exemplary flowchart 400 illustrating the operation of the controller 220 or the network controller 140 according to another embodiment. This flowchart 400 can outline the operation of algorithm execution in step 320 of flowchart 300. In step 405, the flowchart begins. In step 410, a first usage metric or parameter of operation is compared to a threshold. For example, the threshold may be a determination of a type of channel unavailability. This channel unavailability may be a delay of a push-to-talk session, an interruption of a push-to-talk session, of any other event that may adversely affect a push-to-talk session. If a first result is desired, in step 415, a first mitigator can be enabled. For example, a delay mitigator can be enabled if it is desired to reduce the delay of a push-to-talk session. This delay mitigator can be the establishment of a packet switched session, the enablement of a delay of the release of a session, the enablement of a reverse session after the release of a session, or any other delay mitigator. In step 420, a first mitigator parameter can be adjusted according to a function of a metric or parameter of operation. For example, the delay time until the release of a session can be adjusted as a function of the measured actual delay between subsequent sessions.

If a second result is desired, in step 425, a second mitigator can be enabled. For example, an interruption mitigator can be enabled if it is desired to reduce the interruptions of a push-to-talk session. This interruption mitigator can be the establishment of a circuit switched session, the prohibition of handoff, or any other useful interruption mitigator. In step 430, a second mitigator parameter can be adjusted according to a function of a metric or parameter of operation. For example, a handoff delay can be adjusted based on a measurement of PTT session interruption time, or the duration of PTT the session. Thus, the handoff may only be prohibited or delayed for a set period of time, thereby avoiding situations in which a call may be dropped when the communication device becomes out of range from the original cell.

In step 435, a second usage metric or parameter of operation is compared to a threshold. For example, the threshold may be the delay between a first session and a subsequent session. The delay can be compared to the threshold by determining if the actual delay between subsequent, unreturned sessions from one terminal 120 is below a certain threshold. If the delay is below a threshold, in step 440 a third mitigator is enabled. For example, the third mitigator can maintain a session after a user releases the session if the user often initiates a subsequent session without a response in a relatively short period of time. In this example, a user may often communicate by only enabling a session for a few words, releasing a push-to-talk button for a pause, and re-engaging the push-to-talk button to continue speaking for a few more words. Thus, the session can be maintained for a short time, despite the user releasing the push-to-talk button, to avoid delays in each session setup. In step 445, a mitigation parameter can be set as a function of a metric. For example, the delay of the release of a push-to-talk session can be set as a function of the actual delay between subsequent sessions. Thus, for example, if the user typically initiates a subsequent session in under a ten second pause, the delay can be set to approximately ten seconds.

If, in step 435, the delay is above a certain threshold, in step 450 a fourth mitigation can be enabled. In this example, if the delay is above a threshold, the fourth mitigation can be to turn off the delay mitigation to avoid wasted resources of holding the session for a delayed period after a user releases the session. In step 455, a fourth mitigation parameter can be set as a function of a metric. In this example, because the delay mitigation is disabled, there may be no mitigation parameter to set. Alternately, the delay mitigation parameter can be set to a maximum value in case the delay mitigation is later enabled. The flowchart 400 can then continue to compare other usage metrics such as those disclosed above to various thresholds relevant to the metrics, enable or disable the mitigators based on the comparisons, and adjust relevant parameters and metrics. The flowchart 400 may only compare selected usage metrics to thresholds and then end based on desired results. Alternately, the flowchart 400 can continually compare all usage metrics to thresholds and then recycle to continually compare the metrics to thresholds.

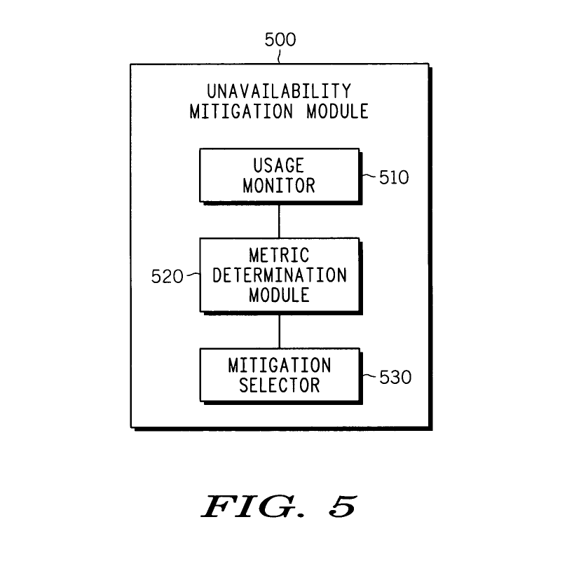

FIG. 5 is an exemplary block diagram of an unavailability mitigation module 500 according on one embodiment. The unavailability mitigation module 500 can reside within the network controller 140, within the controller 220, at a base station 172, at a resource manager 150, or anywhere else within the system 100 or within the communication device 200. The unavailability mitigation module 500 may reside within a memory as executable software. Alternatively, the unavailability mitigation module 500 and each element of the unavailability mitigation module 500 may exist as independent hardware devices. The unavailability mitigation module 500 can include a usage monitor 510 configured to monitor push-to-talk usage of a mobile communication device, a metric determination module 520 configured to determine a push-to-talk metric based on the push to talk usage of the mobile communication device, and a mitigation selector 530 configured to select a push-to-talk session unavailability mitigation based on the push-to-talk metric. Each element can operate to execute relevant steps of each of the flowcharts described above. For example, the mitigation selector 530 can select an operation to mitigate the delay of an activation of a push-to-talk session. In particular, the mitigation selector 530 can select an operation to select a packet switched channel type, establish a reverse link for a selected time period unless a reverse push-to-talk session is established, and/or hold a push-to-talk connection for a selected time period after release of a push-to-talk button unless a subsequent push-to-talk session is established. Additionally, the mitigation selector 530 can select an operation to mitigate the interruption of a push-to-talk channel. For example, the mitigation selector 530 can select an operation to select a circuit switched channel type, prohibit a network handover of the mobile communication device, and/or prohibit a network handover of the mobile communication device for a selected time period.

The metric determination module 520 can determine the push-to-talk metric based on a measurement of a length of a delay of a push-to-talk channel activation and/or a probability of an activation of a subsequent push-to-talk session. Additionally, the metric determination module 520 can determine the push-to-talk metric based on a time measurement of the length of time of a push-to-talk channel interruption, and/or a probability of a push-to-talk channel interruption. Furthermore, the metric determination module 520 can determine the push-to-talk metric based on a time between subsequent push-to-talk sessions from the same mobile communication device, and/or a probability of subsequent push-to-talk sessions from the same mobile communication device. Also, the metric determination module 520 can determine the push-to-talk metric based on a probability of a push-to-talk session from one mobile communication device and a subsequent push-to-talk session from a another mobile communication device on a reverse channel. Additionally, the metric determination module 520 can determine the push-to-talk metric based on a length of time of a push-to-talk session and/or a probability of handoff of the push-to-talk session.

The method of this invention is preferably implemented on a programmed processor. However, the controller 220, the network controller 140, and/or the unavailability mitigation module 500 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the invention by simply employing the elements of the independent claims. Accordingly, the preferred embodiments of the invention as set forth herein are intended to be illustrative, not limiting. Various changes may be made without departing from the spirit and scope of the invention.

1. A method of push-to-talk operation, comprising:
monitoring push-to-talk usage of a mobile communication device;
determining a push-to-talk metric based on the push to talk usage of the mobile communication device; and
selecting a push-to-talk session unavailability mitigation based on the push-to-talk metric.

2. The method of push-to-talk operation according to claim 1, wherein the session unavailability comprises one of a delay of an activation of a push-to-talk session and an interruption of a push-to-talk session.

3. The method of push-to-talk operation according to claim 1, wherein the session unavailability mitigation comprises a mitigation of delay of an activation of a push-to-talk session.

4. The method of push-to-talk operation according to claim 1, wherein the session unavailability mitigation further comprises selecting a packet switched channel type.

5. The method of push-to-talk operation according to claim 1, wherein the session unavailability mitigation further comprises establishing a reverse link for a selected time period in anticipation that a reverse push-to-talk session is established.

6. The method of push-to-talk operation according to claim 1, wherein the session unavailability mitigation comprises holding a push-to-talk connection for a selected time period after release of a push-to-talk button in anticipation that a subsequent push-to-talk session is established.

7. The method of push-to-talk operation according to claim 1, wherein the session unavailability mitigation is a mitigation of interruption of a push-to-talk channel.

8. The method of push-to-talk operation according to claim 1, wherein the session unavailability mitigation comprises selecting a circuit switched channel type.

9. The method of push-to-talk operation according to claim 1, wherein the session unavailability mitigation comprises prohibiting a network handover of the mobile communication device.

10. The method of push-to-talk operation according to claim 1, wherein the session unavailability mitigation comprises prohibiting a network handover of the mobile communication device for a selected time period.

11. The method of push-to-talk operation according to claim 1, wherein the push-to-talk metric is based on a measurement of a length of a delay of a push-to-talk channel activation.

12. The method of push-to-talk operation according to claim 1, wherein the push-to-talk metric is based on a probability of an activation of a subsequent push-to-talk session.

13. The method of push-to-talk operation according to claim 1, wherein the push-to-talk metric is based on a time measurement of the length of time of a push-to-talk channel interruption.

14. The method of push-to-talk operation according to claim 1, wherein the push-to-talk metric is based on a probability of a push-to-talk channel interruption.

15. The method of push-to-talk operation according to claim 1, wherein the push-to-talk metric is based on a time between subsequent push-to-talk sessions from the same mobile communication device.

16. The method of push-to-talk operation according to claim 1, wherein the push-to-talk metric is based on a probability of subsequent push-to-talk sessions from the same mobile communication device.

17. The method of push-to-talk operation according to claim 1, wherein the push-to-talk metric is based on a probability of a push-to-talk session from one mobile communication device and a subsequent push-to-talk session from a another mobile communication device on a reverse channel.

18. The method of push-to-talk operation according to claim 1, wherein the push-to-talk metric is based on a length of time of a push-to-talk session.

19. The method of push-to-talk operation according to claim 1, wherein the push-to-talk metric is based on a probability of handoff of the push-to-talk session.

20. A method of push-to-talk operation for a mobile communication device, comprising:
comparing at least one push-to-talk usage metric to a push-to-talk usage metric threshold;
selecting a session unavailability mitigation based on comparing the push-to-talk usage metric to the push-to-talk usage metric threshold;
establishing a push-to-talk session employing the session unavailability mitigation;
monitoring a parameter of operation of the push-to-talk session; and
modifying the push-to-talk metric based on the parameter of operation of the push-to-talk session.

21. The method of push-to-talk operation according to claim 20, wherein the session unavailability comprises at least one of delay of an activation of a push-to-talk channel and an interruption of a push-to-talk channel.

22. The method of push-to-talk operation according to claim 20, further comprising modifying a session unavailability mitigation parameter as a function of a push-to-talk usage metric.

23. The method of push-to-talk operation according to claim 22, wherein the session unavailability mitigation parameter comprises a time to delay the end of a push-to-talk session after a user releases a push-to-talk button.

24. The method of push-to-talk operation according to claim 22, wherein the session unavailability mitigation parameter comprises a selection of a circuit switched push-to-talk session and a packet switched push-to-talk session.

25. The method of push-to-talk operation according to claim 22, wherein the session unavailability mitigation parameter comprises a duration of a reverse push-to-talk session from another mobile communication device.

26. A method of push-to-talk operation for a mobile communication device, comprising:
loading at least one push-to-talk mitigation parameter;
executing a push-to-talk algorithm to configure at least one push-to-talk session unavailability mitigation based on the push-to-talk mitigation parameter, the push-to-talk session unavailability mitigation controlling the operation of a push-to-talk function of the mobile communication device;
establishing a push-to-talk session for the mobile communication device;
monitoring at least one metric of push-to-talk operation of the mobile communication device;
modifying a push-to-talk mitigation parameter based on the at least one metric of push-to-talk operation of the mobile communication device; and
reconfiguring the at least one push-to-talk session unavailability mitigation based on the modified push-to-talk mitigation parameter.

27. The method of push-to-talk operation according to claim 26, wherein session unavailability comprises one of
a delay of an activation of a push-to-talk session, and
an interruption of a push-to-talk session.

28. The method of push-to-talk operation according to claim 26, wherein the session unavailability mitigation comprises one of
selecting a packet switched channel type,
establishing a reverse link for a selected time period unless a reverse push-to-talk session is established, and
holding a push-to-talk connection for a selected time period after release of a push-to-talk button unless a subsequent push-to-talk session is established.

29. The method of push-to-talk operation according to claim 26, wherein the session unavailability mitigation comprises one of
selecting a circuit switched channel type,
prohibiting a network handover of the mobile communication device, and
prohibiting a network handover of the mobile communication device for a selected time period.

30. An apparatus for push-to-talk operation, comprising:
a usage monitor configured to monitor push-to-talk usage of a mobile communication device;
a metric determination module configured to determine a push-to-talk metric based on the push to talk usage of the mobile communication device; and
a mitigation selector configured to select a push-to-talk session unavailability mitigation based on the push-to-talk metric.

31. The apparatus for push-to-talk operation according to claim 30, wherein the session unavailability mitigation comprises a mitigation of delay of an activation of a push-to-talk session.

32. The apparatus for push-to-talk operation according to claim 30, wherein the session unavailability mitigation further comprises one of
selecting a packet switched channel type,
establishing a reverse link for a selected time period in anticipation that a reverse push-to-talk session is established, and
holding a push-to-talk connection for a selected time period after release of a push-to-talk button in anticipation that a subsequent push-to-talk session is established.

33. The apparatus for push-to-talk operation according to claim 30, wherein the session unavailability mitigation is a mitigation of interruption of a push-to-talk channel.

34. The apparatus for push-to-talk operation according to claim 30, wherein the session unavailability mitigation comprises one of
selecting a circuit switched channel type,
prohibiting a network handover of the mobile communication device, and
prohibiting a network handover of the mobile communication device for a selected time period.

35. The apparatus for push-to-talk operation according to claim 30, wherein the push-to-talk metric is based on one of
a measurement of a length of a delay of a push-to-talk channel activation, and
a probability of an activation of a subsequent push-to-talk session.

36. The apparatus for push-to-talk operation according to claim 30, wherein the push-to-talk metric is based on one of
a time measurement of the length of time of a push-to-talk channel interruption, and
a probability of a push-to-talk channel interruption.

37. The apparatus for push-to-talk operation according to claim 30, wherein the push-to-talk metric is based on one of
a time between subsequent push-to-talk sessions from the same mobile communication device, and
a probability of subsequent push-to-talk sessions from the same mobile communication device.

38. The apparatus for push-to-talk operation according to claim 30, wherein the push-to-talk metric is based on a probability of a push-to-talk session from one mobile communication device and a subsequent push-to-talk session from a another mobile communication device on a reverse channel.

39. The apparatus for push-to-talk operation according to claim 30, wherein the push-to-talk metric is based on one of
a length of time of a push-to-talk session, and
a probability of handoff of the push-to-talk session.
